(19) United States
(12) Patent Application Publication
(10) Pub. No.: US 2003/0178355 A1
(43) Pub. Date: Sep. 25, 2003

(54) Reverse osmosis tank with integral quick release fitting

(76) Inventor: Dale Beach, Corona, CA (US)

Correspondence Address: FUESS & DAVIDENAS, Suite II-G, 10951 Sorrento Valley Road, San Diego, CA, 92121-1613, US

(21) Appl. No.: 10/106,988

(22) Filed: Mar. 25, 2002

(51) Int. Cl. B01D 65/00

(52) U.S. Cl. 210/232; 137/315.01; 137/798

(57) ABSTRACT

A tank for use in connection with a reverse osmosis water purification system includes a first portion of quick connect/disconnect fitting, preferably of the type known as John Guest. A complimentary second portion of the quick connect/disconnect fitting mates with the fitting first portion to permit quick flow connection and disconnection to the tank with, and through, the fitting. The tank-mounted first portion of the quick connect/disconnect fitting is preferably a simple upstanding tube having a circumferential channel; making that the complimentary second portion of the quick connect/disconnect fitting mates with this first portion by selectively compressibly grasping the circumferential channel.

### BACKGROUND OF THE INVENTION

1. Field of the Invention

The present invention generally concerns the plumbing of reverse osmosis systems, including plumbing such as may incorporate quick connect/disconnect, also known as “quick release”, fittings.

The present invention particularly concerns a particular component of a reverse osmosis (RO) system—a pressurized purified-water RO storage tank—having as its plumbed connection to a purified water line a portion of a quick connect/disconnect, also known as a “quick release”, fitting. A complimentary portion of the fitting located on a purified water line, or on a plumbed component such as a valve in the purified water line, permits quick flow connection and disconnection of the RO tank from the purified water line.

2. Description of the Prior Art

Reverse osmosis water purifiers are generally well-known in the art for producing a purified water supply used for drinking, cooking, etc. Such purifiers commonly include a reverse osmosis unit having a reverse osmosis membrane which, in the presence of appropriate flow and pressure conditions, separates an incoming tap or feed water supply into (i) a purified water supply and (ii) a relatively impure, or reject, water supply. In particular, the membrane acts to remove particulate matter and a wide range of dissolved solids and other contaminants from a portion of the tap water to produce the purified water supply, and to concentrate those contaminants within the remainder of the tap water, thereby producing the reject water supply for disposal via a suitable drain.

The purified water is normally collected for storage at a convenient location within a suitable accumulator tank or reservoir, and for ready dispensing through a spigot or the like when desired. In this regard, suitable tanks have generally used either (i) compressed air or (ii) the pressure of the tap water supply to deliver purified water from the tank. Various reverse osmosis apparatuses have been described in the literature.

2.1 General Plumbing of Reverse Osmosis Systems

U.S. Pat. No. 5,122,265 entitled “Compact Reverse Osmosis System with Cold Water Flush” which issued Jun. 16, 1992 to Mora, et al. discloses a reverse osmosis system in which there is a manifold having water supplied through a line, an elbow and a union connector. Pure water leaves the R/O unit through an exit and a second line. Waste is removed through another exit and a drain line.

U.S. Pat. No. 4,885,085 entitled “Direct Acting Reverse Osmosis Water Purifier Valves” which issued Dec. 5, 1989 to Beall, Jr. provides a reverse osmosis water purification system having a valve which has a water inlet, a purified water outlet, a drain line and several other connections.

U.S. Pat. No. 5,045,197 entitled “Reverse Osmosis Purification System with Unitary Header Manifold” which issued Sep. 3, 1991 to Burrows shows a reverse osmosis purification system having a manifold which has a water supply inlet fitting, a drain fitting and two pure water fittings.

U.S. Pat. No. 5,133,858 entitled “Reverse Osmosis Water Purification Apparatus” which issued Jul. 28, 1992 to Walz et al. discloses a reverse osmosis water purification apparatus having a mounting bracket and a R/O unit.

2.2 Quick Connect Plumbing of Reverse Osmosis Systems

Reverse osmosis water purifiers are generally positioned in cabinet space underneath sinks and the like. Connections are made between the reverse osmosis water purifier to the tap water input line, a spigot, the drain, ice maker and the like. The plethora of connections has generally required a plumber experienced in reverse osmosis systems to handle any service, filter changes and the like since locating even a simple item such as the incoming water on/off valve can be a daunting prospect for the average homeowner. Thus, there is a need for a connector system which allows easy and quick servicing of reverse osmosis water purifiers.

It is known to use quick-connect fittings within a reverse osmosis system, although, to the best knowledge of the inventor, neither in the particular location, nor in the manner, envisioned by the present invention.

In this regard, a number of patents to Walling, et al. for a CONNECTOR SYSTEM FOR USE WITH REVERSE OSMOSIS WATER PURIFIER represent the current, circa 2001, state of the art in quick connect/disconnect RO systems. Exemplary is U.S. Pat. No. 5,660,720 describing a connector system for use in connection with a reverse osmosis water purification system having an inlet line, a drain line, an outlet line, and a storage tank mounted on the outlet line providing a reservoir of purified water. The storage tank is pressurized to force the purified water from the reservoir through the outlet line. The connector system comprises an inlet fitting connecting an incoming water line to an inlet on the reverse osmosis water purification system, an on/off inlet valve mounted to the inlet fitting, a spigot fitting connecting the outlet line to a spigot, a drain fitting connecting the drain line to a drain, a tank fitting having an on/off valve connecting the tank to the outlet line, a fitting for releasing the pressure, and an accessory fitting connecting the outlet line to an accessory. The connector system further includes a monitor checking the quality of the water moving through the connector system. The connector system mounts all of the fittings and the monitor to a convenient surface.

### SUMMARY OF THE INVENTION

The present invention contemplates a pressurized purified water storage tank for a reverse osmosis (RO) system which tank has at its plumbed connection to a purified water line (or some component upon the purified water line such as, most notably, a valve) support for flow connection via a quick connect/disconnect, also known as a quick release, fitting.

More precisely, the present invention contemplates a pressurized purified-water storage tank in an RO system where the tank integrally incorporates a (first) portion of a quick connect/disconnect, also known as a “quick release”, fitting. A complimentary, second, portion of the same quick release fitting is located in the purified water line. Quick flow connection or disconnection of the RO tank to a purified water line is thus supported.

### OBJECTS OF THE INVENTION

A primary object of the present invention is to thus permit the quick connection, disconnection and removal, and/or re-connection of the purified water storage tank of a RO system, therein saving labor upon each of tank (i) installation, (ii) removal for cleaning or repair and/or (iii) re-installation.

This labor saving comes at a trade-off of, potentially, a slight increase in the cost not particularly of the tank itself (which tank is commonly somewhat cheaper than when comparably equipped with the traditional threaded fitting of the prior art), but of the purified water line to which the tank connects. This is because the purified water line must now flow connect to the tank in and through a portion of a quick connect/disconnect fitting that is of proper complimentary form to that portion of the fitting that is integral with the tank.

This trade-off of (i) installation labor for (ii) the cost of the quick connect fitting is normally an economically good one.

This is especially true if, as is typical, the tank must occasionally be replaced over a span of years while the purified water line, which most commonly incorporates the more expensive portion of the fitting, is not replaced.

Another object of the present invention is the simplification of both the (i) hook up and (ii) disconnection of diverse purified water storage tanks of residential and light commercial reverse osmosis systems. These systems most typically have plumbing lines and plumbed connections ranging from ¼ to ⅜ inch in size, although application of the invention is not limited to this size range. The preferred quick connect fittings of the present invention are so self-evidently obvious, and easy, to use that they may be successfully manipulated by an untrained homeowner without tools or even, in most cases, instructions.

Yet another object of the present invention is to accord greater flexibility and serviceability to installers when locating the reverse osmosis system and, particularly, its tank component. Since connection of the RO tank is via a quick-connect fitting normally manipulatable in but one hand, the tank and its connecting purified water line may flexibly be located in a relatively inaccessible location.

Still yet another object of the present invention is to accord one-handed hook-up and removal of hard-to-reach reverse osmosis system tanks without the use of tools.

In a most preferred embodiment of the present invention where that portion of the quick connect fitting that is present in the purified water line (and complimentary with a another portion of the fitting integral to the RO tank) is conjoined with a valve, the present invention benefits the user/owner with quick and effortless emergency control in case of plumbing problems, including both (i) controlling outflow of purified water from the tank whether attached in the RO system or not, and, separately, (ii) permitting disconnection of the tank as may be closed by the valve for transport as a water reservoir in the event of civil emergency.

2. A RO Tank Integrally Incorporating a Portion of a Ouick Connect/Disconnect Fitting

Accordingly, in one of its aspects the present invention is embodied in a tank for use in connection with a reverse osmosis water purification system.

In accordance with the invention, the tank integrally incorporates a first portion of quick connect/disconnect fitting. By this structure quick both flow connection and disconnection to the tank may be made with, and through, a complimentary second portion of the quick connect/disconnect fitting that serves to mate with the first portion.

The tank-integrated first portion of quick connect/disconnect fitting is preferably but a simple tube having an external circumferential channel. In this case the complimentary second portion of the quick connect/disconnect fitting mating with this first portion acts to selectively compressibly grasp this circumferential channel. A quick connect/disconnect fitting of this famous type is commonly known as a “John Guest fitting”, after its inventor.

Moreover, and still further preferably, (i) this first portion of quick connect/disconnect fitting in the form of a simple tube having a circumferential channel preferably mates with (ii) a complimentary second portion of the fitting which is itself integral with a valve. By this structure, and this coaction, the tank is not merely susceptible of being quickly flow-connected and disconnected, but is further controllably so flow-connected and disconnected by action of this valve that is integral with the second portion of the quick connect/disconnect fitting.

3. Emergency Detachment and Transport of the RO Tank and Its Purified Water Contents as a Reservoir, Including Both e With and Without Both Portions of the Ouick Connect/Disconnect Fitting

In another of its aspects the present invention is embodied in a method of detaching and transporting the RO tank and its purified water contents, including for use as a water reservoir in the event of an emergency. The tank may be detached and transported with its own portion, or, by severing the connection of the fitting portion that is upon the purified water line, with both portions of the quick connect/disconnect fitting.

When the tank is simply detached—quick released—that “tube” portion of the preferred, John Guest type, fitting that is upon the tank preferably has, as a special configuration of such a John Guest fitting, threads in its interior bore. (Since this tubular fitting portion attaches at its exterior, these interior features are special, and abnormal.) By these interior threads to the tube when the tank is not flow connected (to and through a complimentary second portion of a quick connect/disconnect fitting) then its tube opening can be occluded by the simple expedient of threading a common machine screw into the threaded bore of the tube. Although this screw plug serves to seal the tank, which may or may not contain purified water, in a less flexible and convenient manner than does the (quick-connect) valve discussed in the preceding paragraph, the use of a threaded screw to seal shut the tank is (i) cheaper than a pressure cap, commonly made of brass, to the threaded fittings of a conventional tank, (ii) very reliable, and, as recessed into the tube, (iii) substantially immune from damage and/or from being accidentally dislodged. A screw-plugged tank in accordance with the present invention may be safely, reliably and leaklessly transported with purified water inside, including as a portable water supply in the event of civil emergency. The purified water contents of the tank may be accessed by the simple expedient of unscrewing the plug screw.

The possibility also exists of severing the second portion of the preferred John Guest type fitting from the purified water supply line. Thus may be accomplished by (1) breaking or otherwise separating the fitting (portion) from the line, or by (ii) cutting the line, normally with a stub left attached to the fitting (portion). When the fitting portion is integral with a valve, as next discussed, the detached tank has and presents its own valve, and possibly also a short dispensing line, which again facilitates use of the tank outside of the RO system, and as a dispensing water storage reservoir, in the event of an emergency. Existing RO tanks are not perceived to be used for this purpose, and are ill configured to be so used.

4. A Method of Flow-Connecting a Tank for Use in Connection with a Reverse Osmosis Water Purification System

In another of its aspects the present invention is embodied in a method of flow-connecting a tank for use in connection with a reverse osmosis water purification system.

The method includes (i) integrally incorporating a first portion of quick connect/disconnect fitting in a wall of the tank; (ii) affixing a second portion of the quick connect/disconnect fitting, complimentary with the first portion, to a purified water line; and (iii) quickly flow connecting the tank to the purified water line by simple expedient of mating the fitting's second portion that is affixed to the purified water line to the fitting's first portion that is integral to the tank.

The integrally incorporating is preferably of a first portion of a fitting preferably in the form of a tube having a circumferential channel. The affixing of the second portion is preferably by compressively attaching the second portion of the fitting that is upon the purified water line to this first portion of the fitting that is upon the tank. This flow-connecting thus transpires quickly, and by plugging in the manner of a John Guest type fitting.

The method preferably further includes (iv) controlling fluid flow through the flow connected tank and water line by action of making a valve to be integral with the fitting's second portion.

The method may be extended to disconnection of the tank previously flow-connected. In this extended method the tank is flow disconnected from the purified water line by the quite obvious, and normal, step of detaching the fitting's second portion that is affixed to the purified water line from the fitting's first portion that is integral to the tank. However, and more significantly, in accordance with the present invention the tank so flow disconnected is preferably plugged by threading a screw into a bore of the tube.

These and other aspects and attributes of the present invention will become increasingly clear upon reference to the following drawings and accompanying specification.

### BRIEF DESCRIPTION OF THE DRAWINGS

Referring particularly to the drawings for the purpose of illustration only and not to limit the scope of the invention in any way, these illustrations follow:

FIG. 1 is an exploded diagrammatic view of (i) a preferred reverse osmosis tank with a first, preferably male, portion of a preferred quick release fitting in accordance with the present invention, and also, further, (ii) an optional preferred valve (quick) releasably attaching to this tank fitting portion (and also quick-releasably to a further water line) further in accordance with the present invention.

FIG. 2 is a side plan view at expanded scale of that portion, preferably male as illustrated, of the quick release fitting that was, in accordance with the present invention, permanently integrally affixed to the reverse osmosis tank previously seen in FIG. 1.

### DESCRIPTION OF THE PREFERRED EMBODIMENT

The following description is of the best mode presently contemplated for the carrying out of the invention. This description is made for the purpose of illustrating the general principles of the invention, and is not to be taken in a limiting sense. The scope of the invention is best determined by reference to the appended claims.

Although specific embodiments of the invention will now be described with reference to the drawings, it should be understood that such embodiments are by way of example only and are merely illustrative of but a small number of the many possible specific embodiments to which the principles of the invention may be applied. Various changes and modifications obvious to one skilled in the art to which the invention pertains are deemed to be within the spirit, scope and contemplation of the invention as further defined in the appended claims.

1. Environment of the Present Invention Where a Tank, Particularly for Reverse Osmosis, Integrally Incorporates a First Portion of a Ouick Release Fitting

The elements, and construction, of a Reverse Osmosis, RO, system are well known in the art. An exemplary teaching of the function of an RO system is contained in U.S. Pat. No. 5,660,720 to Walling for a CONNECTOR SYSTEM FOR USE WITH REVERSE OSMOSIS WATER PURIFIER, the contents of which patent are incorporated herein by reference.

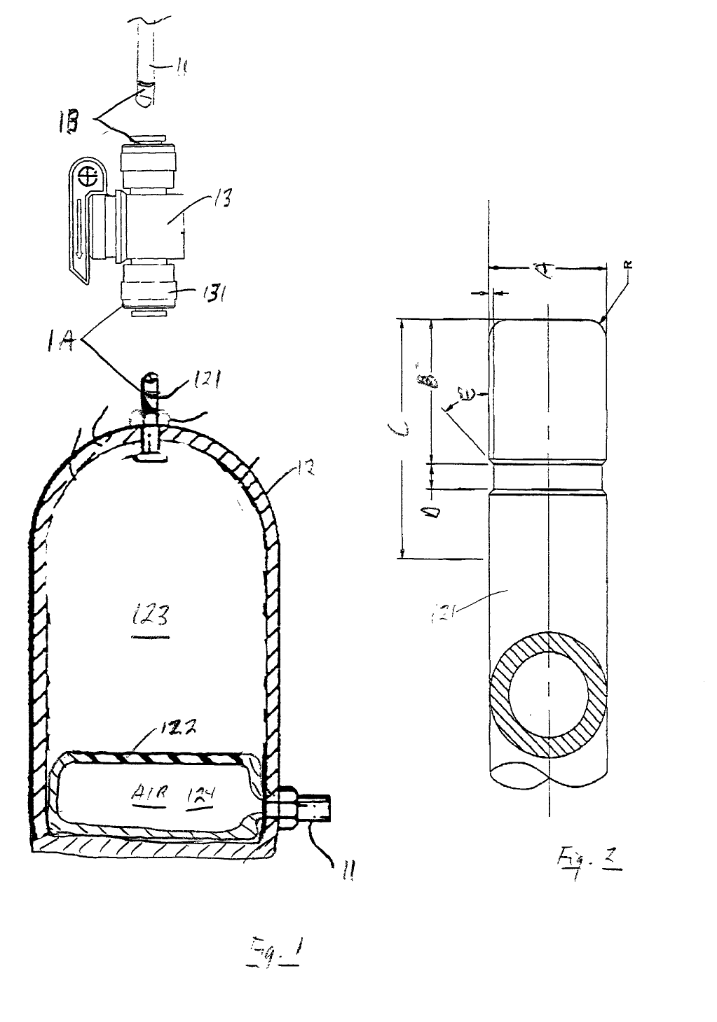

Unpurified, or tap water, enters such an RO system and is directed via piping to the a reverse osmosis filter, or unit having a reverse osmosis membrane (all not shown) which, in the presence of appropriate flow and pressure conditions, separates the incoming tap water supply into a purified water supply and a relatively impure or reject water supply. The purified water supply exiting the RO unit travels to an purified water spigot (not shown) and also, most commonly via a “T” fitting (not shown) via a pipe 11 (a portion of which is shown in FIG. 1) to a purified water tank 12 (shown in FIG. 1). The simple purpose of the tank 12 is to store purified water so that it may be at times withdrawn from the RO system faster than it is presently being made by the RO filter, or “RO unit” (not shown).

In accordance with the present invention, a valve 13 is usefully, optionally, mounted in the line 11 between the RO unit (not shown) and the purified water storage tank 12 for several purposes. The valve 13 may be shut off, or closed, in order that the purified water storage tank 12 may be removed for maintenance or replacement, in which case the valve 13 remains attached to the line 11.

However, and especially when the RO system is turned off such as for lack of tap water, then it is also possible to envision that the valve 13 is disconnectable from the line 11, and stays with the purified water tank 12—as it may in the preferred configuration of this valve 13 in the preferred configuration of the present invention shown in FIG. 1. In this case the RO tank may be removed with its contents or purified water and both (i) transported and (ii) emptied, including under force of gravity, as requirements dictate. For example, and RO tank 12 and accompanying, still-attached, valve 13 may serve as reservoir of fresh water in the event of a civil emergency disrupting normal water supply, such as an earthquake.

2. A Tank, Particularly for Reverse Osmosis, Integrally Incorporating a First Portion of a Ouick Release Fitting

Referring more particularly to the drawings by characters of reference, FIG. 1 shows both (i) a preferred reverse osmosis tank 12 in accordance with the present invention having a first, preferably male, portion 121 of a preferred quick release fitting 1A, and also, further, (ii) an optional preferred valve 13 (quick) releasably attaching to this tank fitting portion 121 via its own quick (female) quick release fitting portion 131. This valve 13 preferably still further, and again, quick-releasably connects via another quick release fitting 1B to the purified water line 11. A practitioner of the plumbing arts will recognize that should the optional valve 13 not be present at the terminus of the purified water line 11 then it would be possible for the tank 12 to quick connect directly to a complimentary fitting portion directly upon the purified water line at its terminus (variant not illustrated).

Indeed, those skilled in the art will recognize that many devices and methods of quick connecting the purified RO water tank 12 to the purified water line 11, the gravamen of one aspect of the present invention being simply that the purified RO water tank 12 should incorporate a (first) portion of such a quick-release fitting in the first place, which incorporation is believed by the inventor to be novel.

The preferred fittings 1A and 1B allow quick disconnecting and reconnecting. They are of the type available from companies such as John Guest USA Inc. of Totowa, N.J. or The Specialty Mfg. Co. of St. Paul, Minn., as well as other suppliers. Such fittings are well-known in the art.

In the preferred embodiment of the tank 12 illustrated in FIG. 1 purified water is directed via pipe 11 to the tank 12. The tank 12 is divided by expandable bladder 122 into a reservoir 123 and a pressurizing volume (of air) 124. The purpose of the tank 12 is to provide an immediate supply of purified water when an outlet such as spigot (not shown) in purified water line 11 is opened, or when some accessory flow-connected to line 11 (and the RO system of which it is a part) calls for water. In addition, tank 12 accumulates water flowing through the RO system during periods when there is no usage of water.

As shown in FIG. 1, water is directed from pipe 11 into reservoir 123. Water will continue to enter reservoir 123 until the pressure in pressurizing volume 124 is equal to the permeate water outlet pressure as measured in line 11, which is commonly approximately equal to 75% of the tap water inlet pressure due to the pressure drop caused by the reverse osmosis membrane. Upon the opening of the spigot or other accessory, water will be forced out of reservoir 123 of the tank 12 by the pressurizing volume 124, through pipe 11 where it is conveyed to the open spigot (not shown) or to satisfy other demands. As is well-known in the art, reservoir 123 and tank 12 are made large enough to accumulate the water flowing through the RO system during periods of no use of purified water.

Pressurizing volume 124 will contain either AIR as illustrated in FIG. 1 or, alternatively, be connected to the reject water from the RO unit via a direct acting or squeeze valve (not shown). As just described, water entering reservoir 123 will compress the air in volume 124 until the air pressure equals the permeate water outlet pressure. Once a spigot or the like in line 11 is opened, the air in volume 124 will begin to expand and force the water from reservoir 123. To allow service, the pressurizing volume 124 may optionally be connected via a pressure fitting to a pipe and hence to an air check valve, preferably a Schrader valve (all not shown) Such an air check valve (not shown) permits release of the compressed air from volume 124, or addition of air to volume 124, as desired. Pressurizing and Schrader valves are well-known in the art.

To permit service of tank 12 the normally open valve 13 os closed. The valve 13 permits service of tank 12 without disconnecting the entire RO unit. Once the valve 13 is shut, the tank 12 is isolated from the RO unit (not shown).

3. That Portion of the Preferred Ouick Release Fitting Which is Integrally Affixed to the Tank

That portion 121, preferably male as illustrated, of the quick release 1A fitting that was, in accordance with the present invention, permanently integrally affixed to the reverse osmosis tank 12 is shown at expanded scale in side plan view in FIG. 2.

Diameter A and distances B and C are typically as per the following table dependent upon the size of the tank 12 and its associated quick-connector:

| Seal | | | |
|---|---|---|---|
| Size | A | B | C |
| 4 | .250 | .29 | .75 |
| 5 | .313 | .44 | 1.18 |
| 6 | .375 | .44 | 1.27 |
| 7 | .500 | .46 | 1.31 |

All dimensions are in inches. The tolerance of dimension A is ±0.005″, of dimension B is ±0.010″, and dimension C is a minimum. Dimension D is 0.050″±0.010″, and angle E is typically 45°.

The seals are preferably type “TrueSeal”, and are either plastic or neoprene rubber.

The system of the present invention is suitable for use with RO tanks of wide-ranging volumes constructed of most materials, especially the ubiquitous metal RO tanks where the tube portion of the quick release fitting is most commonly permanently brazed, or welded, to the metal tank body.

Although only certain embodiments have been illustrated and described, it will be apparent to those skilled in the art that various changes and modifications may be made therein without departing from the spirit of the invention or from the scope of the appended claims.

In accordance with the preceding explanation, variations and adaptations of the RO tank quick release fitting and system in accordance with the present invention will suggest themselves to a practitioner of the plumbing arts. For example, other types of quick release fittings than the John Guest type could be used. For example, that portion of the fitting that is attached to the RO tank, and that portion that is attached to the purified water line, could be reversed from the showing of the drawings.

In accordance with these and other possible variations and adaptations of the present invention, the scope of the invention should be determined in accordance with the following claims, only, and not solely in accordance with that embodiment within which the invention has been taught.

What is claimed is:

1. A tank for use in connection with a reverse osmosis water purification system, the tank comprising:
a first portion of quick connect/disconnect fitting;
wherein quick flow connection and disconnection to the tank may be made with, and through, a complimentary second portion of the quick connect/disconnect fitting mating with the first portion.

2. The tank according to claim 1 wherein the first portion of quick connect/disconnect fitting comprises:
a tube having a circumferential channel;
wherein a complimentary second portion of the quick connect/disconnect fitting mating with this first portion selectively compressibly grasps the circumferential channel;
wherein the quick connect/disconnect fitting is of the type commonly known as John Guest.

3. The tank according to claim 2
wherein the first portion of quick connect/disconnect fitting in the form of a simple tube having a circumferential channel mates with a complimentary second portion integrally incorporating a valve;
wherein the tank is not merely quickly flow connected and disconnected, but is further controllably so flow connected and disconnected by action of the valve that is integral with the second portion of the quick connect/disconnect fitting.

4. The tank according to claim 2
wherein the tube has threads in its interior bore;
wherein a tube of a tank not flow connected to and through a complimentary second portion of a quick connect/disconnect fitting can be occluded by the simple expedient of threading a screw into the threaded bore of the tube.

5. A method of flow connecting a tank for use in connection with a reverse osmosis water purification system, the method comprising:
integrally incorporating a first portion of quick connect/disconnect fitting in a wall of the tank;
affixing a second portion of the quick connect/disconnect fitting, complimentary with the first portion, to a purified water line; and
quickly flow connecting the tank to the purified water line by simple expedient of mating the fitting's second portion that is affixed to the purified water line to the fitting's first portion that is integral to the tank.

6. The flow connection method according to claim 5
wherein the integrally incorporating is of a fitting first portion in the form of a tube having a circumferential channel;
wherein the affixing of the second portion is by compressively attaching the purified water line; and
wherein the quickly flow connecting is by plugging in the manner of a John Guest type fitting.

7. The flow connection method according to claim 5 further comprising:
controlling flow through the flow connected tank and water line by action of a valve integral with the fitting's second portion.

8. The flow connection method according to claim 7 extended to disconnection of the tank previously flow-connected, the extended method further comprising:
flow disconnecting the tank from the purified water line by detaching the fitting's second portion that is affixed to the purified water line from the fitting's first portion that is integral to the tank; and
stopping further flow from the tank so flow disconnected by action of threading a screw into a bore of the tube to act as a plug.

9. The flow connection system according to claim 8 further comprising:
providing an additional fitting for releasing the pressure within the storage tank; and
mounting the additional fitting to the surface of the tank.

10. In a reverse osmosis water purification system having an inlet line, a drain line, an outlet line, and a pressurized storage tank providing a reservoir of purified water mounted on the outlet line, an improvement to the pressurized storage tank comprising:
a quick release fitting connecting the tank to the outlet line.
